(19) United States
(12) Patent Application Publication
(10) Pub. No.: US 2008/0188625 A1
(43) Pub. Date: Aug. 7, 2008

(54) Carboxyl Group-Containing Polyurethane and Thermosetting Resin Composition Using the Same

(75) Inventors: Hiroshi Uchida, Kanagawa (JP); Kazuya Kimura, Kanagawa (JP); Yuko Sakata, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 11/885,258

(22) PCT Filed: Mar. 3, 2006
(86) PCT No.: PCT/JP2006/304674

§ 371 Date: Aug. 29, 2007

Related U.S. Application Data
(60) Provisional application No. 60/661,902, filed on Mar. 16, 2005.
(60) Provisional application No. 60/662,389, filed on Mar. 17, 2005.

(30) Foreign Application Priority Data
Mar. 4, 2005 (JP) 2005-061421
Mar. 7, 2005 (JP) 2005-062397

(51) Int. Cl. C08L 75/04

(52) U.S. Cl. 525/403; 528/85

(57) ABSTRACT

The invention relates to a carboxyl group-containing polyurethane, which is obtained by reacting (a) a polyisocyanate compound, (b) a polycarbonate diol having a molecular weight of 300 to 50,000, (c) a dihydroxy compound having a carboxyl group and when necessary (d) a monohydroxy compound, a thermosetting composition using the carboxyl group-containing polyurethane and a paste for forming a film using thermosetting composition. The thermosetting composition of the invention is excellent in adhesion to a substrate, low warpage, flexibility, plating resistance and soldering heat resistance.

### CROSS-REFERENCE TO RELATED APPLICATIONS

This is an application filed pursuant to 35 U.S.C. Section 111(a) with claiming the benefit of U.S. provisional application No. 661,902 filed Mar. 16, 2005 and U.S. provisional application No. 662,389 filed Mar. 17, 2005 under the provision of 35 U.S.C. 111(b), pursuant to 35 U.S.C. Section 119(e)(1).

### TECHNICAL FIELD

The present invention relates to a carboxyl group-containing polyurethane resin prepared from a polycarbonate as raw material having a specific structure and a thermosetting resin composition produced by combining the carboxyl group-containing polyurethane resin and an epoxy resin, and also relates to a paste for forming a film in which a solvent and specific inorganic and/or organic fine particles are blended in the thermosetting resin composition. The thermosetting resin composition according to the invention can provide a thermosetting composition excellent in adhesion to a substrate, low warpage, flexibility, plating resistance and soldering heat resistance, and can be expected to find applications in the fields of, for example, an electric insulating material such as a solder resist or an interlayer insulating film, a sealing material for an IC or ultra LSI, and a laminate.

### BACKGROUND ART

In a solder resist ink, there is a problem in that warpage is caused due to a large curing shrinkage and a large cooling shrinkage after curing. For the purpose of solving this problem, for example, a resist ink composition of epoxy resin type which contains an epoxy resin and a dibasic acid anhydride as essential components as disclosed in JP-B No. 5-75032 has been proposed. However, when such a composition is adjusted so as to give low warpage and high flexibility to a film to be formed from the resist ink composition, there is a problem that plating resistance and soldering heat resistance are deteriorated. Further, using a dibasic acid anhydride involves a problem that long-term insulation property under high temperature and high humidity conditions is low.

### DISCLOSURE OF THE INVENTION

An object of the present invention is to provide a carboxyl group-containing polyurethane resin prepared from a polycarbonate as raw material having a specific structure which can provide a thermosetting composition excellent in adhesion to a substrate, low warpage, flexibility, plating resistance and soldering heat resistance and a thermosetting resin composition produced by combining the carboxyl group-containing polyurethane resin and an epoxy resin, and also provide a paste for forming a film, in which a solvent and specific inorganic and/or organic fine particles are blended in the thermosetting resin composition.

In order to solve the above-described problems, the present inventors have exerted intensive studies and, as a result, have found that a thermosetting resin composition produced by combining a carboxyl group-containing polyurethane resin prepared through reaction between a polyisocyanate compound, a dihydroxy compound having a carboxyl group and if necessary a monohydroxy compound by using a polycarbonate having a specific structure as raw material with an epoxy resin is excellent in adhesion to a substrate, flexibility, plating resistance, soldering heat resistance and a long-term insulation property under high temperature/high humidity conditions, whereby they have achieved the present invention.

Namely, the present invention relates to a carboxyl group-containing polyurethane prepared from a polycarbonate as raw material having a specific structure as follows and a thermosetting resin composition as follows, and also relates to a paste for forming a film, which contains a solvent and specific inorganic and/or organic fine particles blended therein.

1. A carboxyl group-containing polyurethane, which is obtained by reacting (a) a polyisocyanate compound, (b) a polycarbonate diol having a molecular weight of 300 to 50,000, (c) a dihydroxy compound having a carboxyl group and when necessary (d) a monohydroxy compound.

2. The carboxyl group-containing polyurethane according to 1 above, wherein 10 mol % or more of diol components constituting (b) the polycarbonate diol having a molecular weight of 300 to 50,000 consists of alicyclic compound having 6 to 30 carbon atoms.

3. The carboxyl group-containing polyurethane according to 2 above, wherein the diol containing alicyclic compound having 6 to 30 carbon atoms is at least one kind selected from a group consisting of 1,4-cyclohexane dimethanol, 1,3-cyclohexane dimethanol, 1,4-cyclohexane diol, 1,3-cyclohexane diol, tricyclodecane dimethanol and pentacyclopentadecane dimethanol.

4. The carboxyl group-containing polyurethane according to any one of 1 to 3 above, wherein the number average molecular weight is from 500 to 100,000 and the acid value is from 5 to 150 mg KOH/g.

5. The carboxyl group-containing polyurethane according to 1 above, wherein (c) the dihydroxy compound having a carboxyl group is dimethylolpropionic acid and/or dimethylolbutanoic acid.

6. The carboxyl group-containing polyurethane according to 1 above, wherein 10 mol % or more of (a) the polyisocyanate compound is an alicyclic compound having 6 to 30 carbon atoms excluding carbon atoms in the isocyanate groups.

7. The carboxyl group-containing polyurethane according to 1 or 6 above, wherein (a) the polyisocyanate compound is at least one kind selected from a group consisting of 1,4-cyclohexane diisocyanate, isophorone diisocyanate, methylene-bis(cyclohexyl isocyanate), cyclohexane-1,3-dimethylene diisocyanate and cyclohexane-1,4-dimethylene diisocyanate.

8. The carboxyl group-containing polyurethane according to 1 above, wherein (d) the monohydroxy compound is at least one kind selected from a group consisting of hydroxyethyl acrylate, hydroxyethyl(meth)acrylate, allyl alcohol, glycolic acid and hydroxypivalic acid.

9. The carboxyl group-containing polyurethane according to 1 to 6 above, wherein (d) the monohydroxy compound is at least one kind selected from a group consisting of methanol, ethanol, n-propanol, isopropanol, n-butanol, isobutanol, sec-butanol and t-butanol.

10. A thermosetting resin composition, comprising:
(A) 100 parts by mass of a carboxyl group-containing polyurethane resin in which 10% by mol or more of diol components constituting a polycarbonate diol having a molecular weight of from 300 to 50,000 uses an alicyclic compound having 6 to 30 carbon atoms as a raw material and
(B) 1 to 100 parts by mass of epoxy resin.

11. The thermosetting resin composition according to 10 above, wherein the carboxyl group-containing polyurethane resin (A) is a carboxyl group-containing polyurethane resin described in 2 above.

12. The thermosetting resin composition according to 10 above, wherein the epoxy resin (B) is at least one type selected from among a bisphenol A type epoxy resin, a bisphenol F type epoxy resin, a phenol novolak type epoxy resin, an o-cresol novolak type epoxy resin, a biphenyl type epoxy resin, an amine type epoxy resin, a hetero ring-containing epoxy resin and an alicyclic epoxy resin.

13. The thermosetting resin composition according to 10 or 11 above, wherein the acid value of the carboxyl group-containing polyurethane resin (A) is from 5 to 150 mg KOH/g.

14. The thermosetting resin composition according to any one of 10 to 13 above, wherein the amount of epoxy group in the epoxy resin (B) is from 0.2 to 2 equivalents with respect to the carboxyl group of the carboxyl group-containing polyurethane resin (A).

15. The thermosetting resin composition according to any one of 10 to 14 above, wherein the number average molecular weight of the carboxylic group-containing polyurethane resin (A) is from 500 to 100,000.

16. The thermosetting resin composition according to any one of 10 to 15 above, wherein a non-nitrogen-containing polar solvent is used as an organic solvent in both (A) 100 parts by mass of a carboxyl group-containing polyurethane resin in which 10% by mol or more of diol components constituting a polycarbonate diol having a molecular weight of from 300 to 50,000 uses an alicyclic compound having 6 to 30 carbon atoms as a raw material and (B) 1 to 100 parts by mass of epoxy resin.

17. The thermosetting resin composition according to any one of 10 to 16 above, wherein (A) 100 parts by mass of a carboxyl group-containing polyurethane resin in which 10% by mol or more of diol components constituting a polycarbonate diol having a molecular weight of from 300 to 50,000 uses an alicyclic compound having 6 to 30 carbon atoms as a raw material, (B) 1 to 100 parts by mass of epoxy resin and (C) from 1 to 90 parts by mass of inorganic and/or organic fine particles are blended in.

18. The thermosetting resin composition according to any one of 10 to 17 above, wherein a curing agent (D) is contained in an amount of from 0.1 to 25% by mass based on the thermosetting resin components (A)+(B).

19. The thermosetting resin composition according to any one of 10 to 18 above, wherein the curing agent (D) is at least one type selected from among an amine, a quaternary ammonium salt, an acid anhydride, polyamide, a nitrogen-containing heterocyclic compound and an organic metal compound.

20. A paste for forming a film, using the thermosetting composition according to any one of 10 to 19 above.

### BEST MODE FOR CARRYING OUT THE INVENTION

Hereinafter, the present invention is described in detail.

The invention relates to a carboxyl group-containing polyurethane resin obtained by using polycarbonate having a specific structure as a raw material and a thermosetting resin composition comprising combination of the carboxyl group-containing polyurethane resin and an epoxy resin, and also relates to a paste for forming a film, which is prepared by blending a solvent and specific inorganic and/or organic fine particles into the thermosetting resin composition.

### <Polyurethane Resin>

The carboxyl group-containing polyurethane of the present invention is obtained by reacting (a) a polyisocyanate compound, (b) a polycarbonate diol having a molecular weight of 300 to 50,000, (c) a dihydroxy compound having a carboxyl group and when necessary (d) a monohydroxy compound.

Examples of (a) polyisocyanate compound include diisocyanates such as 2,4-toluene diisocyanate, 2,6-toluene diisocyanate, isophorone diisocyanate, 1,6-hexamethylene diisocyanate, 1,3-trimethylenediisocyanate, 1,4-tetramethylene diisocyanate, 2,2,4-trimethylhexamethylene diisocyanate, 2,4,4-trimethylhexamethylene diisocyanate, 1,9-nonamethylene diisocyanate, 1,10-decamethylene diisocyanate, 1,4-cyclohexane diisocyanate, 2,2′-diethylether diisocyanate, diphenylmethane diisocyanate, (o, m, or p)-xylene diisocyanate, methylene-bis(cyclohexyl isocyanate), cyclohexane-1,3-dimethylene diisocyanate, cyclohexane-1,4-dimethylene diisocyanate, 1,5-naphthalene diisocyanate, p-phenylene diisocyanate, 3,3′-methylene ditolylene-4,4′-diisocyanate, 4,4′-diphenylether diisocyanate, tetrachlorophenylene diisocyanate and norbornane diisocyanate. One of these diisocyanates can be used independently or two or more kinds thereof may be used in combination.

Further, a small amount of a polyisocyanate having 3 or more isocyanate groups such as triphenylmethane triisocyanate can be used within a range that does not cause gelation.

Among these, when analicyclic compound having 6 to 30 carbon atoms excluding carbon atoms in the isocyanate groups is used, a property of excellent reliability in long-term insulation performance under high temperature/high humidity conditions is exhibited. Examples of polyisocyanate having an alicyclic compound having 6 to 30 carbon atoms excluding carbon atoms in the isocyanate groups include cyclohexane diisocyanate, isophorone diisocyanate, methylene bis(cyclohexylisocyanate), cyclohexane-1,3-dimethylene diisocyanate and cyclohexane-1,4-dimethylene diisocyanate.

In order to exhibit preferable properties, it is preferable to use the polyisocyanate having an alicyclic compound having 6 to 30 carbon atoms excluding carbon atoms in the isocyanate groups in an amount of 10 mol % or more, preferably 30 mol % or more based on the total amount of the polyisocyanate components.

As (b) polycarbonate diol having a molecular weight of 300 to 50,000, polycarbonate diols having a structure where diol components such as 1,3-propane diol, 1,4-butane diol, 1,5-pentane diol, 1,6-hexane diol, 3-methyl-1,5-pentane diol, 2-methyl-1,8-octane diol, 1,9-nonane diol, 1,4-cyclohexane dimethanol, 1,3-cyclohexane dimethanol, 1,4-cyclohexane diol, 1,3-cyclohexane diol, tricyclohexane dimethanol and pentacyclopentadecane dimethanol are linked through carbonate bonds are preferred. Two or more kinds of these diol components may be combined. One of these polycarbonate diols may be used independently or two or more kinds thereof may be used in combination.

Among these, in a case where a diol having an alicylclic compound having 6 to 30 carbon atoms is used, properties particularly excellent in long-term insulation performance under high temperature/high humidity conditions are exhibited. Examples of diol having an alicyclic compound having 6 to 30 carbon atoms include 1,4-cyclohexane dimethanol, 1,3-cyclohexane dimethanol, 1,4-cyclohexane diol, 1,3-cyclohexane diol, tricyclodecane dimethanol and pentacyclopentadecane dimethanol.

In order to exhibit preferable properties, it is preferable to use the diol having an alicyclic compound having 6 to 30 carbon atoms in an amount of 10 mol % or more, preferably 30 mol % or more based on the total amount of the diol components in the polycarbonate polyol.

Examples of (c) dihydroxy compound having a carboxylic group include dimethylol propionic acid, dimethylol butanoic acid, N,N-bis-hydroxyethyl glycine and N,N-bis-hydroxyethyl alanine. Among these compounds, in terms of solubility in solvents, dimethylol propionic acid and dimethylol butanoic acid are preferred. One of these hydroxyl compounds each having a carboxyl group may be used independently or two or more kinds thereof may be used in combination.

The carboxyl group-containing polyurethane can be synthesized by using only the three components (a), (b) and (c), however, for the purpose of imparting a radical polymerization property or a cationic polymerization property or for the purpose of eliminating an influence of a terminal isocyanate residue, (d) a monohydroxy compound may be allowed to participate in the reaction.

As (d) monohydroxy compound, examples of those having a radically polymerizable double bond include 2-hydroxyethyl(meth)acrylate, hydroxypropyl(meth)acrylate, hydroxybutyl(meth)acrylate, a caprolactone- or an alkylene oxide-adduct of any one of these (meth)acrylates, glycerin di(meth)acrylate, trimethylol di(meth)acrylate, pentaerythritol tri(meth)acryalte, dipentaerythritol penta(meth)acrylate, ditrimethylolpropane tri(meth)acrylate, allyl alcohol and allyloxyethanol. Examples of those having a carboxylic acid include glycolic acid and hydroxypivalic acid.

One of these monohydroxy compounds may be used independently or two or more kinds thereof may be used in combination. Further, among these compounds, 2-hydroxyethyl(meth)acrylate, hydroxypropyl(meth)acrylate, hydroxybutyl(meth)acrylate, allyl alcohol, glycolic acid, and hydroxypivalic acid are preferred and 2-hydroxyethyl(meth)acrylate is more preferred.

Further, examples of the monohydroxy compound to be added for the purpose of eliminating the influence of the terminal isocyanate residue include methanol, ethanol, n-propanol, isopropanol, n-butanol, isobutanol, sec-butanol, t-butanol, amyl alcohol, hexyl alcohol and octyl alcohol.

A molecular weight of the carboxyl group-containing polyurethane according to the invention is preferably from 500 to 100,000 and, particularly preferably, from 2,000 to 30,000. The molecular weight mentioned herein denotes a value in terms of polystyrene measured by gel permeation chromatography. When the molecular weight is less than 500, an elongation degree, flexibility and strength of a cured film may sometimes be impaired, while, when the molecular weight exceeds 100,000, solubility in solvents is lowered and, even when it is forced to be dissolved, the viscosity becomes unduly high, which leads to many restrictions in uses of the invention.

An acid value of the carboxyl group-containing polyurethane according to the invention is preferably from 5 to 150 mg KOH/g and, particularly preferably, from 10 to 120 mg KOH/g. When the acid value is less than 5 mg KOH/g, reactivity with an epoxy is lowered and, then, heat resistance may sometimes be impaired. On the other hand, the acid value exceeding 150 mg KOH/g leads to undue hardness and fragility as defects of a cured film.

Further, the acid value of the resin described in the present Specification was measured in accordance with the method described below.

About 0.2 g of sample was accurately measured by using a precision balance and placed in a 100 ml-volume Erlenmeyer flask. Then 10 ml of mixed solvent of ethanol/toluene: 1/2 was added thereto to dissolve the sample. Further, from one to three drops of an ethanol solution of phenolphthalein was added into this flask as an indicator and the mixture was stirred well until the sample solution became uniform. The resultant solution was titrated with a 0.1 N potassium hydroxide-ethanol solution and, the time point when light pink color of the indicator lasted for 30 seconds was determined to be the terminal point of neutralization. The value calculated by using the formula below is defined as an acid value of the resin.

Acid value (mg KOH/g)=[B×f×5.611]/S
B: amount of 0.1 N potassium hydroxide-ethanol solution (ml)
f: factor of 0.1 N potassium hydroxide-ethanol solution
S: amount of sample collected (g)

The carboxyl group-containing polyurethane of the present invention can be obtained by allowing (a) a polyisocyanate compound, (b) a polycarbonate diol having a molecular weight of 300 to 50,000, (c) a dihydroxy compound having a carboxyl group and when necessary (d) a monohydroxy compound to react with each other in an appropriate solvent in the presence or absence of an appropriate urethanization catalyst such as dibutyl tin dilaurate.

The reaction mode is not particularly limited, however, representative examples of the reaction to be implemented on industrial scale are shown below.

Any solvent may be used as long as the solvent has low reactivity with isocyanate. Examples of the solvents include toluene, xylene, ethylbenzene, nitrobenzene, cyclohexane, isophorone, diethyleneglycol dimethyl ether, ethyleneglycol diethyl ether, propyleneglycol methyl ether acetate, propyleneglycol ethyl ether acetate, dipropyleneglycol methyl ether acetate, diethyleneglycol ethyl ether acetate, methyl methoxypropionate, ethyl methoxypropionate, methyl ethoxypropionate, ethyl ethoxypropionate, ethyl acetate, n-butyl acetate, isoamyl acetate, ethyl lactate, acetone, methylethyl ketone, cyclohexanone, N,N-dimethyl formamide, N,N-dimethyl acetamide, N-methyl pyrrolidone, y-butyrolactone, dimethyl sulfoxide, chloroform and methylene chloride. Those in which the produced carboxyl group-containing polyurethane shows low solubility are not preferred. Further, in consideration for properties at the time of preparation of ink to be used in electric materials, preferred among the above examples are propyleneglycol methyl ether acetate, propyleneglycol ethyl ether acetate, dipropyleneglycol methyl ether acetate, diethyleneglycol ethyl ether acetate and γ-butyrolactone. The concentration of carboxyl group-containing polyurethane in the reaction solution is preferably from 10 to 90% by weight, more preferably from 40 to 80% by weight.

The order of blending the raw materials is not particularly limited, however, generally speaking, diol compounds (b) and (c) are first incorporated to be dissolved in a solvent and then (a) diisocyanate compound is dropwise added thereto at a temperature of 20 to 150° C., preferably 60 to 120° C. Subsequently, reaction is conducted at 50 to 160° C., preferably 70 to 130° C.

The mole ratio of the raw materials to be blended is to be adjusted according to the target molecular weight and acid value. In a case where (d) a monohydroxy compound is incorporated, an excess amount of (a) diisocyanate compound must be used, as compared with diol compounds (b) and (c), so that the terminals can be isocyanates.

At the time point when reaction between diol and disocyanate is almost completed, (d) a monohydroxy compound is dropwise added at a temperature of 20 to 150° C., preferably 70 to 120° C. to thereby react with isocyanates remaining at both terminals of the reaction product. Subsequently, the reaction mixture is kept at the same temperature, to thereby complete the reaction.

### <Thermosetting Resin Composition>

The thermosetting resin composition according to the invention contains:

(A) 100 parts by mass of a carboxyl group-containing polyurethane resin, in which 10% by mol or more of diol components constituting a polycarbonate diol having a molecular weight of from 300 to 50000 uses an alicyclic compound having from 6 to 30 carbon atoms as a raw material; and

(B) from 1 to 100 parts by mass of epoxy resin.

(A) The carboxyl group-containing polyurethane resin, which uses a polycarbonate diol having a molecular weight of from 300 to 50,000 as a raw material according to the invention can be obtained by allowing the following components:

(a) a polyisocyanate compound,

(b) a diol which is a polycarbonate diol, having a molecular weight of from 300 to 50,000, wherein at least 10 mol % or more thereof consists of alicyclic compound having 6 to 30 carbon atoms,

(c) a dihydroxyl compound containing a carboxyl group, and if necessary,

(d) a monohydroxy compound

to react with one another. That is, in the aforementioned carboxyl group-containing polyurethane resin, (b)polycarbonate diol is specified as above.

When the molecular weight of the polycarbonate diol is less than 300, a cured product formed of the thermosetting resin composition which comprises a carboxyl group-containing polyurethane synthesized by using the polycarbonate diol as a raw material is inferior in flexibility, while, when the molecular weight exceeds 50,000, a carboxyl group-containing polyurethane synthesized by using the polycarbonate diol as a raw material is not compatible with the epoxy resin (B). Moreover, such an excessively large molecular weight may cause deterioration in plating resistance and soldering heat resistance of a cured product of the composition. Still further, when the ratio of the alicyclic compound in the diol components is less than 10% by mol, the plating resistance and the soldering heat resistance of the thermosetting resin composition to be obtained are inferior.

Further, in the diol components constituting the polycarbonate diol (b), diols such as 1,3-propane diol, 1,4-butane diol, 1,5-pentane diol, 1,6-hexane diol, 3-methyl-1,5-pentane diol, 2-methyl-1,8-octane diol and 1,9-nonane diol may be contained within a range of less than 90% by mol. One of these diols may be used independently or two or more kinds thereof may be used in combination.

Examples of epoxy resins (B) used in the thermosetting resin according to the invention include bisphenol A type epoxy resins such as Epikote 828, Epikote 1002 and Epikote 1004 (all trade names) produced by Japan Epoxy Resin K.K.;

bisphenol F type epoxy resins such as Epikote 806, Epikote 807 and Epikote 4005P (all trade names) produced by Japan Epoxy Resin K.K. and YDF-170 (trade name) produced by Tohto Kasei Co., Ltd.; phenol novolak type epoxy resins such as Epikote 152 and Epikote 154 (all trade names) produced by Japan Epoxy Resin K.K., EPPN-201 (trade name) produced by Nippon Kayaku Co., Ltd. and DEN-438 (trade name) produced by Dow Chemical Co.;

o-cresol novolak type epoxy resins such as EOCN-125S, EOCN-103S and EOCN-104S (all trade names) produced by Nippon Kayaku Co., Ltd.;

biphenyl type epoxy resins such as Epikote YX-4000 and Epikote YL-6640 (all trade names) produced by Japan Epoxy Resin K.K.;

multifunctional epoxy resins such as Epikote 1031S (trade name) produced by Japan Epoxy Resin K.K., Araldite 0163 (all trade names) produced by Ciba Specialty Chemicals, and Denacol EX-611, Denacol EX-614, Denacol EX-614B, Denacol EX-622, Denacol EX-512, Denacol EX-521, Denacol EX-421, Denacol E-411 and Denacol EX-321 (all trade names) produced by Nagase Chemicals Ltd.;

amine type epoxy resins such as Epikote 604 (trade name) produced by Japan Epoxy Resin K.K., YH-434 (trade name) produced by Tohto Kasei Co., Ltd., TETRAD-X, TETRAD-C (all trade names) produced by Mitsubishi Gas Chemical Co., Inc., GAN (trade name) produced by Nippon Kayaku Co., Ltd., and ELM-120 (trade name) produced by Sumitomo Chemical Co., Ltd.;

hetero ring-containing epoxy resins such as Araldite PT810 (trade name) produced by Ciba specialty Chemicals; and

alicyclic epoxy resins such as ERL4234, ERL4299, ERL4221 and ERL4206 (all trade names) produced by UCC. One of these epoxy resins can be used individually or two or more kinds thereof may be used in combination.

Among these epoxy resins, the bisphenol A type epoxy resins, bisphenol F type epoxy resins and biphenyl type epoxy resins are more preferred in terms of mechanical properties, adhesiveness and bending resistance. Epoxy equivalent is preferably from 155 to 20,000 and, more preferably, from 155 to 2,000.

An amount of the epoxy resin (B) according to the invention to be used is, based on 100 parts by mass of the carboxyl group-containing polyurethane resin(A), from 1 to 100 parts by mass and, preferably, from 5 to 50 parts by mass. When the amount of the epoxy resin to be blended in is less than 1 part by mass, heat resistance, adhesiveness and bending resistance are reduced, while, when the amount exceeds 10 parts by mass, warping resistance and mechanical strength are reduced.

Further, based on the carboxyl group in the carboxyl group-containing polyurethane resin (A), it is preferable that the amount of the epoxy group in the epoxy resin (B) be from 0.2 to 2 equivalents and, more preferably, from 0.5 to 1.5 equivalents. When it is less than 0.2 equivalents, curing property is lowered, while, when it exceeds 2 equivalents, storage stability is lowered.

The thermosetting resin according to the invention can be dissolved or dispersed in an appropriate organic solvent, to thereby prepare a paste for forming a film. Preferred as such an organic solvent are nitrogen-non-containing polar solvents. Examples of the solvents include:

ether type solvents such as diethyleneglycol dimethyl ether, diethyleneglycol diethyl ether, triethyleneglycol dimethyl ether, and triethyleneglycol diethyl ether;

sulfur-containing solvents such as dimethyl sulfoxide, diethyl sulfoxide, dimethyl sulfone, and sulfolane;

ester type solvents such as γ-butyrolactone, diethyleneglycol monomethyl ether acetate, ethyleneglycol monomethyl ether acetate, propyleneglycol monomethyl ether acetate, diethyleneglycol monoethyl ether acetate, ethyleneglycol monoethyl ether acetate and propyleneglycol monoethyl ether acetate;

ketone type solvents such as cyclohexanone and methylethyl ketone; and aromatic hydrocarbon type solvents such as toluene, xylene and petroleum naphtha. One of these solvents can be used each individually or two or more kinds thereof may be used in combination. Particularly preferred examples of solvents capable of imparting high volatility and low-temperature curability include γ-butyrolactone, diethyleneglycol monomethyl ether acetate, ethyleneglycol monomethyl ether acetate, propyleneglycol monomethyl ether acetate, diethyleneglycol monoethyl ether acetate, ethyleneglycol monoethyl ether acetate and propyleneglycol monoethyl ether acetate. As for these solvents, those which have been used as solvents for synthesizing a carboxyl group-containing polyurethane resin can be used as is.

The inorganic and/or organic fine particles (C) according to the invention are not particularly limited so long as they can be dispersed in the carboxyl group-containing polyurethane resin (A) or a solution thereof and the epoxy resin (B) or a solution thereof, to thereby form a paste. Examples of such inorganic fine particles include silica (SiO₂), alumina (Al₂O₃), titania (TiO₂), tantalum oxide (Ta₂O₅), zirconia (ZrO₂), silicon nitride (Si₃N₄), barium titanate (BaO.TiO₂), barium carbonate (BaCO₃), lead titanate (PbO.TiO₂), lead zirconium titanate (PZT), lead lanthanum zirconium titanate (PLZT), gallium oxide (Ga₂O₃), spinel (MgO.Al₂O₃), mullite (3Al₂O₃.2SiO₂), cordierite(2MgO.2Al₂O₃/5SiO₂), talc (3MgO.4SiO₂.H₂O), aluminum titanate (TiO₂—Al₂O₃), yttria-containing zirconium (Y₂O₃-ZrO₂), barium silicate (BaO.8SiO₂), boron nitride (BN), calcium carbonate (CaCO₃), calcium sulfate (CaSO₄), zinc oxide (ZnO), magnesium titanate (MgO.TiO₂) and barium sulfate (BaSO₄). An organic bentonite, carbon (C) and the like can also be used. One of these fine particles can be used individually or two or more kinds thereof may be used in combination.

Further, the organic fine particles to be used in the invention are not particularly limited, so long as they can be dispersed in the carboxyl group-containing polyurethane resin (A) or epoxy resin (B) or a solution thereof to form a paste. Preferred as such organic fine particles are fine particles of a heat resistant resin having an amide bond, an imide bond, an ester bond or an ether bond. As the heat resistant resin, from the viewpoint of the heat resistance and mechanical properties, fine particles of a polyimide resin or a precursor thereof, a polyamideimide resin or a precursor thereof or a polyamide resin are preferably used.

In the thermosetting resin composition according to the invention, in order to further enhance properties such as adhesiveness, chemical resistance and heat resistance, a curing agent (D) is used. Examples of such curing agents (D) include known and conventional curing agents or curing promoters such as imidazole derivatives such as Curesol 2MZ, 2E4MZ, C₁₁Z, C₁₇Z, 2PZ, 1B2MZ, 2MZ-CN, 2E4MZ-CN, C₁₁Z-CN, 2PZ-CN, 2PHZ-CN, 2MZ-CNS, 2E4MZ-CNS, 2PZ-CNS, 2MZ-AZINE, 2E4MZ-AZINE, C₁₁Z-AZINE, 2MA-OK, 2P4MHZ, 2PHZ, and 2P4BHZ (all trade names) produced by Shikoku Chemicals Corp.; guanamines such as acetoguanamine and benzoguanamine; polyamines such as diaminodiphenylmethane, m-phenylenediamine, m-xylenediamine, diaminodiphenyl sulfone, dicyandiamide, urea, urea derivatives, melamine and polybasic hydrazides; organic acid salts thereof and/or an epoxy adducts thereof; amine complexes of boron trifluoride; triazine derivatives such as ethyldiamino-S-triazine, 2,4-diamino-S-triazine and 2,4-diamino-6-xylyl-S-triazine; amines such as trimethylamine, triethanolamine, N,N-dimethyloctylamine, N-benzyldimethylamine, pyridine, N-methylmorpholine, hexa(N-methyl)melamine, 2,4,6-tris(dimethylaminophenol), tetramethylguanidine, and m-aminophenol; polyphenols such as polyvinylphenol, brominated polyvinylphenol, phenolic novolak and alkylphenolic novolak; organophosphines such as tributylphosphine, triphenylphosphine, and tris-2-cyanoethylphosphine; phosphonium salts such as tri-n-butyl-(2,5-dihydroxyphenyl)phosphonium bromide and hexadecyltributylphosphonium chloride; quaternary ammonium salts such as benzyltrimethylammonium chloride and phenyltributylammonium chloride; anhydrides of the aforementioned polybasic acids; photo-cationic polymerization catalysts such as diphenyliodonium tetrafluoroborate, triphenylsulfonium hexafluoroantimonate, 2,4,6-triphenylthiopyrilium hexafluorophosphate, IRGACURE 261 produced by CIBA-GEIGY Japan Ltd. and OPTOMER SP-170 produced by Asahi Denka Kogyo K.K.; a styrene-maleic anhydride resin; and equimolar reaction products of phenyl isocyanate with dimethylamine and of an organic polyisocyanate such as tolylene diisocyanate or isophorone diisocyanate with dimethylamine.

It is necessary to select an appropriate curing agent (D) in accordance with types of the components (A) and (B) to be cured. One curing agent (D) can be used singly or a mixture of two or more kinds may be used. The amount of the curing agent (D) to be used is, based on the weight of the components (A) and (B) to be cured, preferably from 0.1 to 25% by mass and, more preferably, from 0.5 to 15% by mass. When the blending amount of the curing agent (D) is, based on the weight of the thermosetting resin composition according to the invention, less than 0.1% by mass, curing of the composition results insufficient, while, when it exceeds 25% by mass, an amount of components sublimated from a cured product thereof is large, which is not preferred.

In order to enhance workability at the time of coating and film properties before and after forming a film, surfactants such as a defoaming agent and a leveling agent, colorants such as a dye and a pigment, a curing promoter, a heat stabilizer, an antioxidant, a flame retardant and a lubricant may be added to the thermosetting resin composition and the resin paste formed therefrom according to the invention.

### EXAMPLES

Hereinafter, the present invention is described in detail with reference to Examples, however, the invention is by no means limited thereto.

Gel permeation chromatography (GPC-1:manufactured by Showa Denko K.K.) was used in the measurement of the number average molecular weight and evaluated in terms of polystyrene.

### Example 1

In a reaction vessel equipped with a stirrer, a thermometer and a condenser, 50.3 g (=0.050 mol) of polycarbonate diol UM-CARB100 (trade name; poly(1,4-cyclohexane dimethanol carbonate); produced by Ube Industries, Ltd.) as a polycarbonate diol (b), 14.8 g(=0.10 mol) of dimethylol butanoic acid (produced by Nippon Kasei Chemical Co., Ltd.) as a dihydroxyl compound (c) containing a carboxyl group, 105 g of propyleneglycol methylether acetate (produced by Daicel Chemical Industries, Ltd.) as a solvent were placed and then, the vessel was heated to dissolve all the materials at 90° C. The temperature of the resultant reaction solution was cooled to 70° C. and 34.0 g (=0.175 mol) of Takenate 600 (trade name; 1,4-cyclohexane dimethylene diisocyanate; produced by Mitsui Takeda Chemicals, Inc.) was added dropwise as a polyisocyanate (a) over 20 minutes by using a dropping funnel. After the dropping was completed, reaction was conducted for 4 hours at 80° C. and then, after it was confirmed that almost all of the isocyanate disappeared, 53 mg of Irganox 1010 (trade name; polymerization inhibitor; produced by Ciba Specialty Chemicals) was added to the resultant mixture and 6.03 g (0.052 mol) of 2-hydroxyethyl acrylate (produced by Tokyo Kasei Kogyo Co., Ltd.) as a monohydroxy compound (d) was added dropwise thereto, to further carry out reaction for 2 hours at 85° C.

The number average molecular weight of the resultant carboxyl group-containing polyurethane was 5,471 and the acid value of solid content thereof was 56.1 mg KOH/g.

### Example 2

In a reaction vessel equipped with a stirrer, a thermometer and a condenser, 167.7 g (=0.167 mol) of polycarbonate diol UM-CARB100 (trade name; poly(1,4-cyclohexane dimethanol carbonate); produced by Ube Industries, Ltd.) as a polycarbonate diol (b), 49.8 g(=0.336 mol) of dimethylol butanoic acid (produced by Nippon Kasei Chemical Co., Ltd.) as a dihydroxyl compound (c) containing a carboxyl group, 359 g of diethyleneglycol ethylether acetate (produced by Daicel Chemical Industries, Ltd.) as a solvent were placed and then, the vessel was heated to thereby dissolve all the materials at 90° C. The temperature of the resultant reaction solution was cooled to 75° C. and then 129.6 g (=0.583 mol) of Desmodur I (trade name; isophorone diisocyanate; produced by Sumika Bayer Urethane Co., Ltd.) was added dropwise thereto as a polyisocyanate (a) over 5 minutes by using a dropping funnel. After the dropping was completed, reaction was conducted for 2 hours at 80° C. and then, 12.7 g (0.171 mol) of isobutanol (produced by Tokyo Kasei Kogyo Co., Ltd.) as a monohydroxy compound (d) was added dropwise to the resultant mixture, to further carry out reaction for 2.5 hours at 85° C.

The number average molecular weight of the resultant carboxyl group-containing polyurethane was 4,312 and the acid value of solid content thereof was 53.9 mg KOH/g.

### Example 3

In a reaction vessel equipped with a stirrer, a thermometer and a condenser, 181.4 g (=0.200 mol) of polycarbonate diol UM-CARB90 (3/1) (trade name; copolymer comprising as diol components 1,4-cyclohexane dimethanol/1,6-hexane diol at a ratio of 3/1;produced by Ube Industries, Ltd.) as a polycarbonate diol (b), 59.3 g (=0.400 mol) of dimethylol butanoic acid (produced by Nippon Kasei Chemical Co., Ltd.) as a dihydroxyl compound (c) containing a carboxyl group, 392 g of diethyleneglycol ethylether acetate (produced by Daicel Chemical Industries, Ltd.) as a solvent were placed and then, the vessel was heated to thereby dissolve all the materials at 90° C. The temperature of the resultant reaction solution was cooled to 70° C. and 136.0 g (=0.700 mol) of Takenate 600 (trade name; 1,4-cyclohexane dimethylene diisocyanate; produced by Mitsui Takeda Chemicals, Inc.) was dropwise added as a polyisocyanate (a) over 15 minutes by using a dropping funnel. After the dropping was completed, reaction was conducted for one hour at 80° C. and another one hour at 85° C. 15.2 g (0.205 mol) of isobutanol (produced by Tokyo Kasei Kogyo Co., Ltd.) as a monohydroxy compound (d) was added dropwise to the resultant mixture and, thereafter, further reaction was carried out for 2 hours at 85° C.

The number average molecular weight of the resultant carboxyl group-containing polyurethane was 3,804 and the acid value of solid content thereof was 52.7 mg KOH/g.

### Example 4

In a reaction vessel equipped with a stirrer, a thermometer and a condenser, 44.7 g (=0.050 mol) of polycarbonate diol UM-CARB90 (1/1) (trade name; copolymer comprising as diol components 1,4-cyclohexane dimethanol/1,6-hexane diol at a ratio of 1/1; produced by Ube. Industries, Ltd.) as a polycarbonate diol (b), 14.8 g (=0.10 mol) of dimethylol butanoic acid (produced by Nippon Kasei Chemical Co., Ltd.) as a dihydroxyl compound (c) containing a carboxyl group, 99.3 g of propyleneglycol methyl ether acetate (produced by Daicel Chemical Industries, Ltd.) as a solvent were placed and then, the vessel was heated to dissolve all the materials at 90° C. The temperature of the resultant reaction solution was cooled to 70° C. and 34.0 g (=0.175 mol) of Takenate 600 (trade name; 1,4-cyclohexane dimethylene diisocyanate; produced by Mitsui Takeda Chemicals, Inc.) was dropwise added as a polyisocyanate (a) over 25 minutes by using a dropping funnel. After the dropping was completed, reaction was conducted for 3 hours at 80° C. and then, 96 mg of Irganox 1010 (trade name; polymerization inhibitor; produced by Ciba Specialty Chemicals) was added to the resultant mixture and 5.85 g (0.050 mol) of 2-hydroxyethyl acrylate (produced by Tokyo Chemical Industry Co., Ltd.) as a monohydroxy compound (d) was dropwise added thereto, to further carry out reaction for 4 hours at 80° C.

The number average molecular weight of the resultant carboxyl group-containing polyurethane was 4,391 and the acid value of solid content thereof was 61.8 mg KOH/g.

### Example 5

In a reaction vessel equipped with a stirrer, a thermometer and a condenser, 44.6 g (=0.050 mol) of polycarbonate diol UM-CARB90 (1/1) (trade name; copolymer comprising as diol components 1,4-cyclohexane dimethanol/1,6-hexane diol at a ratio of 1/1; produced by Ube Industries, Ltd.) as a polycarbonate diol (b), 14.8 g(=0.10 mol) of dimethylol butanoic acid (produced by Nippon Kasei Chemical Co., Ltd.) as a dihydroxyl compound (c) containing a carboxyl group, 98.5 g of propyleneglycol methylether acetate (produced by Daicel Chemical Industries, Ltd.) as a solvent were placed and then, the vessel was heated to dissolve all the materials at 90° C. The temperature of the resultant reaction solution was cooled to 70° C. and 32.9 g (=0.175 mol) of Takenate 500 (trade name; m-xylylene diisocyanate; produced by Mitsui Takeda Chemicals, Inc.) was dropwise added as a polyisocyanate (a) over 5 minutes by using a dropping funnel. After the dropping was completed, reaction was conducted for one hour at 70 ° C. and then, the temperature of the reaction solution was cooled to 75° C. 95 mg of Irganox 1010 (trade name; polymerization inhibitor; produced by Ciba Specialty Chemicals) was added to the resultant solution and 5.85 g (0.050 mol) of 2-hydroxyethyl acrylate (produced by Tokyo Kasei Kogyo Co., Ltd.) as a monohydroxy compound (d) was dropwise added thereto, to further carry out reaction for 3 hours at 75° C.

The number average molecular weight of the resultant carboxyl group-containing polyurethane was 3,299 and the acid value of solid content thereof was 61.9 mg KOH/g.

### Example 6

In a reaction vessel equipped with a stirrer, a thermometer and a condenser, 44.7 g (=0.050 mol) of polycarbonate diol UM-CARB90 (1/1) (trade name; copolymer comprising as diol components 1,4-cyclohexane dimethanol/1,6-hexane diol at a ratio of 1/1; produced by Ube Industries, Ltd.) as a polycarbonate diol (b), 14.8 g(=0.10 mol) of dimethylol butanoic acid (produced by Nippon Kasei Chemical Co., Ltd.) as a dihydroxyl compound (c) containing a carboxyl group, 99.3 g of propyleneglycol methylether acetate (produced by Daicel Chemical Industries, Ltd.) as a solvent were placed and then, the vessel was heated to thereby dissolve all the materials at 90° C. The temperature of the resultant reaction solution was cooled to 70° C. and 40.0 g (=0.238 mol) of DURANATE 50M-HDI (trade name; hexamethylene diisocyanate;produced by Asahi Kasei Chemicals Corporation) was dropwise added as a polyisocyanate (a) over 20 minutes by using a dropping funnel. After the dropping was completed, reaction was conducted for 1.5 hour at 70° C. and after it was confirmed that almost all of the isocyanate disappeared, 96 mg of Irganox 1010 (trade name; polymerization inhibitor; produced by Ciba Specialty Chemicals) was added to the resultant mixture and 5.85 g (0.050 mol) of 2-hydroxyethyl acrylate (produced by Tokyo Kasei Kogyo Co., Ltd.) as a monohydroxy compound (d) was dropwise added thereto, to further carry out reaction for 8 hours at 80° C.

The number average molecular weight of the resultant carboxyl group-containing polyurethane was 3,877 and the acid value of solid content thereof was 61.7 mg KOH/g.

### Example 7

In a reaction vessel equipped with a stirrer, a thermometer and a condenser, 44.7 g (=0.050 mol) of polycarbonate diol UM-CARB90 (1/1) (trade name; copolymer comprising as diol components 1,4-cyclohexane dimethanol/1,6-hexane diol at a ratio of 1/1; produced by Ube Industries, Ltd.) as a polycarbonate diol (b), 14.8 g (=0.10 mol) of dimethylol butanoic acid (produced by Nippon Kasei Chemical Co., Ltd.) as a dihydroxyl compound (c) containing a carboxyl group, 99.3 g of propyleneglycol methylether acetate (produced by Daicel Chemical Industries, Ltd.) as a solvent were placed and then, the vessel was heated to thereby dissolve all the materials at 90° C. The temperature of the resultant reaction solution was cooled to 70° C. and 49.1 g (=0.238 mol) of norbornene diisocyanate (produced by Mitsui Takeda Chemicals, Inc.) was dropwise added as a polyisocyanate (a) over 25 minutes by using a dropping funnel. After the dropping was completed, reaction was conducted for 1.5 hour at 70° C. and then, 96 mg of Irganox 1010 (trade name; polymerization inhibitor; produced by Ciba Specialty Chemicals) was added to the resultant mixture and 5.85 g (0.050 mol) of 2-hydroxyethyl acrylate (produced by Tokyo Kasei Kogyo Co., Ltd.) as a monohydroxy compound (d) was dropwise added thereto, to further carry out reaction for 8 hours at 80° C.

The number average molecular weight of the resultant carboxyl group-containing polyurethane was 3,168 and the acid value of solid content thereof was 56.0 mg KOH/g.

### Example 8

In a reaction vessel equipped with a stirrer, a thermometer and a condenser, 44.7 g (=0.050 mol) of polycarbonate diol UM-CARB90 (1/1) (trade name; copolymer comprising as diol components 1,4-cyclohexane dimethanol/1,6-hexane diol at a ratio of 1/1; produced by Ube Industries, Ltd.) as a polycarbonate diol (b), 14.8 g (=0.100 mol) of dimethylol butanoic acid (produced by Nippon Kasei Chemical Co., Ltd.) as a dihydroxyl compound (c) containing a carboxyl group, 111 g of diethyleneglycol ethylether acetate (produced by Daicel Chemical Industries, Ltd.) as a solvent were placed and then, the vessel was heated to thereby dissolve all the materials at 90° C. The temperature of the resultant reaction solution was cooled to 70° C. and 46.0 g (=0.175 mol) of Desmodur W (trade name; methylene-bis-cyclohexyl isocyanate; produced by Sumika Bayer Urethane Co., Ltd.) was dropwise added as a polyisocyanate over 10 minutes by using a dropping funnel. After the dropping was completed, reaction was conducted for 2 hours at 85° C. and, then, 47 mg of Irganox 1010 (trade name; polymerization inhibitor; produced by Ciba Specialty Chemicals) was added to the resultant mixture and 5.85 g (0.050 mol) of 2-hydroxyethyl acrylate (produced by Tokyo Kasei Kogyo Co., Ltd.) as a monohydroxy compound (d) was dropwise added thereto, to further carry out reaction for 2.5 hours at 90° C.

The number average molecular weight of the resultant carboxyl group-containing polyurethane was 4,442 and the acid value of solid content thereof was 50.5 mg KOH/g.

### Example 9

In a reaction vessel equipped with a stirrer, a thermometer and a condenser, 44.7 g (=0.050 mol) of polycarbonate diol UM-CARB90 (1/1) (trade name;copolymer comprising as diol components 1,4-cyclohexane dimethanol/1,6-hexane diol at a ratio of 1/1; produced by Ube Industries, Ltd.) as a polycarbonate diol (b), 14.8 g (=0.100 mol) of dimethylol butanoic acid (produced by Nippon Kasei Chemical Co., Ltd.) as a dihydroxyl compound (c) containing a carboxyl group, 96.1 g of propyleneglycol methylether acetate (produced by Daicel Chemical Industries, Ltd.) as a solvent were placed and then, the vessel was heated to dissolve all the materials at 90° C. The temperature of the resultant reaction solution was cooled to 70° C. and 30.5 g (=0.175 mol) of Cosmonate TD180 (trade name; 4/1 mixture of 2,4-tolylene diisocyanate/2,6-tolylene diisocyanate; produced by Mitsui Takeda Chemicals, Inc.) was dropwise added as a polyisocyanate (a) over 15 minutes by using a dropping funnel. After the dropping was completed, reaction was conducted for 4 hours at 80° C. 47 mg of Irganox 1010 (trade name; polymerization inhibitor; produced by Ciba Specialty Chemicals) was added to the resultant mixture and 5.85 g (0.050 mol) of 2-hydroxyethyl acrylate (produced by Tokyo Kasei Kogyo Co., Ltd.) as a monohydroxy compound (d) was dropwise added thereto, to further carry out reaction for 3 hours at 85° C.

The number average molecular weight of the resultant carboxyl group-containing polyurethane was 3,831 and the acid value of solid content thereof was 53.6 mg KOH/g.

### Example 10

In a reaction vessel equipped with a stirrer, a thermometer and a condenser, 44.7 g (=0.050 mol) of polycarbonate diol UM-CARB90 (1/1) (trade name; copolymer comprising as diol components 1,4-cyclohexane dimethanol/1,6-hexane diol at a ratio of 1/1; produced by Ube Industries, Ltd.) as a polycarbonate diol (b), 14.8 g (=0.100 mol) of dimethylol butanoic acid (produced by Nippon Kasei Chemical Co., Ltd.) as a dihydroxyl compound (c) containing a carboxyl group, 111 g of propyleneglycol methylether acetate (produced by Daicel Chemical Industries, Ltd.) as a solvent were placed and then, the vessel was heated, to thereby dissolve all the materials at 90° C. The temperature of the resultant reaction solution was cooled to 75° C. and 39.1 g (=0.201 mol) of Takenate 600 (1,4-cyclohexanedimethylene diisocyanate: produced by Mitsui Takeda Chemicals, Inc.) was dropwise added as a polyisocyanate (a) by using a dropping funnel. After the dropping was completed, reaction was conducted for 3 hours at 80° C. 4.35 g (0.057 mol) of glycolic acid (produced by Tokyo Kasei Kogyo Co., Ltd.) as a monohydroxy compound (d) was dropwise added thereto, to further carry out reaction for 2 hours at 85° C.

The number average molecular weight of the resultant carboxyl group-containing polyurethane was 3,892 and the acid value of solid content thereof was 86.6 mg KOH/g.

### Example 11

In a reaction vessel equipped with a stirrer, a thermometer and a condenser, 240 g (=0.24 mol) of polycarbonate diol UM-CARB100 (trade name; poly(1,4-cyclohexanedimethanol)carbonate; molecular weight of about 1,000; produced by Ube Industries, Ltd.) as a polycarbonate diol (b), 35.3 g (=0.24 mol) of dimethylol butanoic acid (produced by Nippon Kasei Chemical Co., Ltd.) as a dihydroxyl compound (c) containing a carboxyl group, 396 g of diethyleneglycol ethylether acetate (produced by DAICEL CHEMICAL INDUSTRIES, LTD.) as a solvent were placed and then, the vessel was heated to dissolve all the materials at 90° C. The temperature of the resultant reaction solution was cooled to 70° C. and 125 g (=0.48 mol) of Desmodur W (trade name; methylene biscyclohexyl isocyanate; produced by Sumika Bayer Urethane Co., Ltd.) was added dropwise as a polyisocyanate (a) over 30 minutes by using a dropping funnel. After the dropping was completed, reaction was conducted for 3 hours at 80° C., 3 hours at 90° C. and then 3 hours at 100° C. After it was confirmed that almost all of the isocyanate disappeared, 4.4 g (0.06 mol) of isobutanol (produced by Wako Pure Chemical Industries, Ltd.) as a monohydroxy compound (d) was dropwise added to the resultant mixture and reaction was further carried out for 1.5 hours at 100° C.

The number average molecular weight of the obtained carboxyl group-containing polyurethane was 7,800 and the acid value of solid content thereof was 35.0 mg KOH/g.

### Example 12

In a reaction vessel equipped with a stirrer, a thermometer and a condenser, 45.3 g (=0.051 mol) of polycarbonate diol UM-CARB90 (1/1) (trade name; copolymer comprising as diol components 1,4-cyclohexane dimethanol/1,6-hexane diol at a ratio of 1/1; molecular weight of about 900; produced by Ube Industries, Ltd.) as a polycarbonate diol (b), 26.7 g (=0.199 mol) of dimethylol propionic acid (produced by Nippon Kasei Chemical Co., Ltd.) as a dihydroxyl compound (c) containing a carboxyl group, 154 g of propyleneglycol methylether acetate (produced by Daicel Chemical Industries, Ltd.) as a solvent were placed and then, the vessel was heated to dissolve all the materials at 90° C. The temperature of the resultant reaction solution was cooled to 70° C. and 66.6 g (=0.300 mol) of Desmodur I (trade name; isophorone diisocyanate; produced by Sumika Bayer Urethane Co., Ltd.) was added dropwise as a polyisocyanate (a) over 30 minutes by using a dropping funnel. After the dropping was completed, reaction was conducted for 4 hours at 80° C. After it was confirmed that almost all the theoretical amount of the isocyanate reacted, the temperature of the reaction liquid was cooled to 70° C. and a mixture of 11.7 g (0.101 mol) of 2-hydroxyethyl acrylate (produced by Tokyo Kasei Kogyo Co., Ltd.) as a monohydroxy compound (d) and 0.4978 g of Irganox 1010 (produced by Ciba Specialty Chemicals) was added to the reaction liquid and reaction was further carried out for 1 hour at 80° C.

The number average molecular weight of the obtained carboxyl group-containing polyurethane was 2,231 and the acid value of solid content thereof was 74.0 mg KOH/g.

### Example 13

In a reaction vessel equipped with a stirrer, a thermometer and a condenser, 44.6 g (=0.049 mol) of polycarbonate diol UM-CARB90 (3/1) (trade name; copolymer comprising as diol components 1,4-cyclohexane dimethanol/1,6-hexane diol at a ratio of 3/1; molecular weight of about 900; produced by Ube Industries, Ltd.) as a polycarbonate diol (b), 14.8 g (=0.100 mol) of dimethylol butanoic acid (Nippon Kasei Chemical Co.,Ltd.) as a dihydroxyl compound (c) containing a carboxyl group, 100 g of propyleneglycol methylether acetate (Daicel Chemical Industries, Ltd.) as a solvent were placed and then, the vessel was heated to dissolve all the materials at 90° C. The temperature of the resultant reaction solution was cooled to 70° C. and 34.0 g (=0.175 mol) of Takenate 600 (trade name; 1,4-cyclohexane dimethylene diisocyanate; produced by Mitsui Takeda Chemicals, Inc.) was dropwise added as a polyisocyanate (a) over 15 minutes by using a dropping funnel. After the dropping was completed, reaction was conducted for 2 hours at 80° C. After it was confirmed that the almost all theoretical amount of the isocyanate reacted, the temperature of the reaction liquid was cooled to 80° C. and a mixture of 5.8 g (0.50 mol) of 2-hydroxyethyl acrylate (produced by Tokyo Kasei Kogyo Co., Ltd.) as a monohydroxy compound (d) and 0.0477 g of Irganox 1010 (produced by Ciba Specialty Chemicals) was dropwise added to the reaction liquid, to thereby carry out further reaction for 2 hours at 85° C.

The number average molecular weight of the obtained carboxyl group-containing polyurethane was 2,532 and the acid value of solid content thereof was 56.2 mg KOH/g.

### Example 14

In a reaction vessel equipped with a stirrer, a thermometer and a condenser, 60.4 g (=0.068 mol) of polycarbonate diol UM-CARB90 (1/1) (trade name; copolymer comprising as diol components 1,4-cyclohexane dimethanol/1,6-hexane diol at a ratio of 1/1; molecular weight of about 900; produced by Ube Industries, Ltd.) as a polycarbonate diol (b), 20.1 g (=0.14 mol) of dimethylol butanoic acid (produced by Nippon Kasei Chemical Co., Ltd.) as a dihydroxyl compound containing a carboxyl group (C), 137 g of propyleneglycol methylether acetate (produced by Daicel Chemical Industries, Ltd.) as a solvent were placed and then, the vessel was heated to dissolve all the materials at 90° C. The temperature of the resultant reaction solution was cooled to 70° C. and 49.1 g (=0.24 mol) of norbornene diisocyanate (produced by Mitsui Fine Chemicals, Inc.) was dropwise added as a polyisocyanate (a) over 30 minutes by using a dropping funnel. After the dropping was completed, reaction was conducted for 1.5 hours at 70° C. After it was confirmed that almost all the theoretical amount of the isocyanate reacted, a mixture of 7.9 g (0.068 mol) of 2-hydroxyethyl acrylate as a monohydroxy compound (d) and 137 mg of Irganox 1010 (produced by Ciba Specialty Chemicals) was dropwise added to the reaction liquid and reaction was further carried out for 6 hours at 80° C.

The number average molecular weight of the obtained carboxyl group-containing polyurethane was 3,168 and the acid value of solid content thereof was 56.0 mg KOH/g.

### Example 15

In a reaction vessel equipped with a stirrer, a thermometer and a condenser, 44.6 g (=0.050 mol) of polycarbonate diol UM-CARB90 (1/1) (trade name; copolymer comprising as diol components 1,4-cyclohexane dimethanol/1,6-hexane diol at a ratio of 1/1; molecular weight of about 900; produced by Ube Industries, Ltd.) as a polycarbonate diol (b), 22.3 g(=0.150 mol) of dimethylol butanoic acid (produced by Nippon Kasei Chemical Co., Ltd.) as a dihydroxyl compound (c) containing a carboxyl group, 101 g of propyleneglycol methylether acetate (produced by Daicel Chemical Industries, Ltd.) as a solvent were placed and then, the vessel was heated to dissolve all the materials at 90° C. The temperature of the resultant reaction solution was cooled to 70° C. and 34.0 g (=0.175 mol) of Takenate 600 (1,4-cyclohexanedimethylene diisocyanate: produced by Mitsui Takeda Chemicals, Inc.) was dropwise added as a polyisocyanate (a) over 10 minutes by using a dropping funnel. After the dropping was completed, reaction was conducted for 6 hours at 80° C.

The number average molecular weight of the obtained carboxyl group-containing polyurethane was 3,935 and the acid value of solid content thereof was 84.2 mg KOH/g.

### Example 16

In a reaction vessel equipped with a stirrer, a thermometer and a condenser, 51.1 g (=0.057 mol) of polycarbonate diol UM-CARB90 (1/1) (trade name; copolymer comprising as diol components 1,4-cyclohexane dimethanol/1,6-hexane diol at a ratio of 1/1; molecular weight of about 900; produced by Ube Industries, Ltd.) as a polycarbonate diol (b), 17.0 g(=0.12 mol) of dimethylol butanoic acid (produced by Nippon Kasei Chemical Co., Ltd.) as a dihydroxyl compound containing a carboxyl group (c), 111 g of propyleneglycol methylether acetate (produced by Daicel Chemical Industries, Ltd.) as a solvent were placed and then, the vessel was heated to dissolve all the materials at 90° C. The temperature of the resultant reaction solution was cooled to 75° C. and 39.1 g (=0.20 mol) of Takenate 600 (1,4-cyclohexanedimethylene diisocyanate: produced by Mitsui Takeda Chemicals, Inc.) was dropwise added as a polyisocyanate (a) by using a dropping funnel. After the dropping was completed, reaction was conducted for 3 hours at 80° C. After it was confirmed that almost all the theoretical amount of the isocyanate reacted, 4.4 g (0.057 mol) of glycolic acid) (produced by Tokyo Kasei Kogyo Co., Ltd.) as a monohydroxy compound (d) was dropwise added to the reaction liquid and reaction was further carried out for 2 hours at 85° C.

The number average molecular weight of the obtained carboxyl group-containing polyurethane was 3,618 and the acid value of solid content thereof was 79.2 mg KOH/g.

### Example 17

In a reaction vessel equipped with a stirrer, a thermometer and a condenser, 51.0 g (=0.057 mol) of polycarbonate diol UM-CARB90 (1/1) (trade name; copolymer comprising as diol components 1,4-cyclohexane dimethanol/1,6-hexane diol at a ratio of 1/1; molecular weight of about 900; produced by Ube Industries, Ltd.) as a polycarbonate diol (b), 17.0 g (=0.12 mol) of dimethylol butanoic acid (produced by Nippon Kasei Chemical Co., Ltd.) as a dihydroxyl compound (c) containing a carboxyl group, 114 g of propyleneglycol methylether acetate (produced by Daicel Chemical Industries, Ltd.) as a solvent were placed and then, the vessel was heated to dissolve all the materials at 90° C. The temperature of the resultant reaction solution was cooled to 70° C. and 38.8 g (=0.20 mol) of Takenate 600 (1,4-cyclohexanedimethylene diisocyanate: produced by Mitsui Takeda Chemicals, Inc.) was dropwise added as a polyisocyanate (a) over 10 minutes by using a dropping funnel. After the dropping was completed, reaction was conducted for 3 hours at 80° C. After it was confirmed that almost all the theoretical amount of the isocyanate reacted, 6.7 g (0.057 mol) of hydroxy pivalic acid) (produced by Tokyo Kasei Kogyo Co., Ltd.) as a monohydroxy compound (d) was dropwise added to the reaction liquid and reaction was further carried out for 2 hours at 85° C.

The number average molecular weight of the obtained carboxyl group-containing polyurethane was 3,681 and the acid value of solid content thereof was 81.9 mg KOH/g.

### Example 18

In a reaction vessel equipped with a stirrer, a thermometer and a condenser, 44.6 g (=0.050 mol) of polycarbonate diol UM-CARB90 (1/1) (trade name; copolymer comprising as diol components 1,4-cyclohexane dimethanol/1,6-hexane diol at a ratio of 1/1; molecular weight of about 900; produced by Ube Industries, Ltd.) as a polycarbonate diol (b), 14.9 g (=0.100 mol) of dimethylol butanoic acid (produced by Nippon Kasei Chemical Co., Ltd.) as a dihydroxyl compound (c) containing a carboxyl group, 111 g of propyleneglycol methylether acetate (produced by Daicel Chemical Industries, Ltd.) as a solvent were placed and then, the vessel was heated to dissolve all the materials at 90° C. The temperature of the resultant reaction solution was cooled to 70° C. and 46.0 g (=0.0175 mol) of Desmodur W was added dropwise over 10 minutes. After the dropping was completed, reaction was conducted for 2 hours at 85° C. After it was confirmed that almost all the theoretical amount of the isocyanate reacted, the temperature of the reaction liquid was cooled to 80° C., and a mixture of 6.0 g (0.051 mol) of 2-hydroxyethyl acrylate(produced by Tokyo Kasei Kogyo Co., Ltd.) as a monohydroxy compound (d) and 0.0466 g of Irganox 1010 (produced by Ciba Specialty Chemicals) was dropwise added to the reaction liquid, to thereby carry out further reaction for 2.5 hours at 90° C.

The number average molecular weight of the obtained carboxyl group-containing polyurethane was 2,123 and the acid value of solid content thereof was 50.5 mg KOH/g.

### Example 19

In a reaction vessel equipped with a stirrer, a thermometer and a condenser, 240 g (=0.24 mol) of polycarbonate diol UM-CARB100 (trade name; poly(1,4-cyclohexanedimethanol carbonate); molecular weight of about 1000; produced by Ube Industries, Ltd.) as a polycarbonate diol (b), 35.3 g (=0.24 mol) of dimethylol butanoic acid (produced by Nippon Kasei Chemical Co., Ltd.) as a dihydroxyl compound (c) containing a carboxyl group, 396 g of γ-butyrolactone (produced by Tokyo Kasei Kogyo Co., Ltd.) as a solvent were placed and then, the vessel was heated to dissolve all the materials at 90° C. The temperature of the resultant reaction solution was cooled to 70° C. and 125.0 g (=0.48 mol) of Desmodur W (produced by Sumika Bayer Urethane Co., Ltd.) was added dropwise over 30 minutes. After the dropping was completed, reaction was conducted for 3 hours at 80° C., for 3 hours at 90° C. and for 3 hours at 100° C. After it was confirmed that almost all the isocyanate disappeared, 4.4 g (0.06 mol) of isobutanol (produced by Wako Pure Chemical Industries, Ltd.) as a monohydroxy compound (d) was dropwise added to the reaction liquid, to thereby carry out further reaction for 1.5 hours at 100° C.

The number average molecular weight of the obtained carboxyl group-containing polyurethane was 13,000 and the acid value of solid content thereof was 35.8 mg KOH/g.

### Example 20

The same procedures as in Example 11 were conducted except that 240 g (0.24 mol) of polycarbonate diol UM-CARB100 (poly(1,6-hexanediol carbonate) produced by Ube Industries, Ltd.; molecular weight of about 1000) was used as polycarbonate diol (b).

The number average molecular weight of the obtained carboxyl group-containing polyurethane was 8,300 and the acid value of solid content thereof was 34.7 mg KOH/g.

### Example 21

The same procedures as in Example 11 were conducted except that 80.7 g (0.48 mol) of Duranate 50M-HDI (hexamethylene diisocyanate produced by Asahi Kasei Chemicals Corporation) was used as a polyisocyanate (a) and that 356 g of diethyleneglycol ethylether acetate (produced by Daicel Chemical Industries, Ltd.) was used as a solvent.

The number average molecular weight of the obtained carboxyl group-containing polyurethane was 9,800 and the acid value of solid content thereof was 37.8 mg KOH/g.

### Comparative Example 1

The same procedures as in Example 11 were conducted except that instead of polycarbonate diol UM-CARB100, 461 g (0.24 mol) of polyester polyol (Placcell produced by Daicel Chemical Industries, Ltd.; molecular weight of about 2000), which is a polymer polyol, was used and that 625 g of diethyleneglycol ethylether acetate (produced by Daicel Chemical Industries, Ltd.) was used as a solvent.

The number average molecular weight of the obtained carboxyl group-containing polyurethane was 12,000 and the acid value of solid content thereof was 21.5 mg KOH/g.

### Examples 22 to 42 and Comparative Example 2

While using the urethane resin solutions obtained in Examples 1 to 21 and Comparative Example 1(solid content: 50% by mass) each as a urethane resin containing a carboxyl group, thermosetting compositions of the mixing ratios shown in Tables 1 and 2 (unit: g) were prepared by kneading them by passing each of the compositions through a 3-roll mill (Model: RIII-1RM-2; manufactured by Odaira Seisakusho, Ltd.) three times.

TABLE 1

| | Examples | | | | | | | | | |
|---|---|---|---|---|---|---|---|---|---|---|
| Polyurethane containing carboxyl group | 22 | 23 | 24 | 25 | 26 | 27 | 28 | 29 | 30 | 31 |
| Example 1 containing 50 mass % of propyleneglycol methylether acetate | 100 | | | | | | | | | |
| Example 2 containing 50 mass % of diethyleneglycol ethylether acetate | | 100 | | | | | | | | |
| Example 3 containing 50 mass % of diethyleneglycol ethylether acetate | | | 100 | | | | | | | |
| Example 4 containing 50 mass % of propyleneglycol methylether acetate | | | | 100 | | | | | | |
| Example 5 containing 50 mass % of propyleneglycol methylether acetate | | | | | 100 | | | | | |
| Example 6 containing 50 mass % of propyleneglycol methylether acetate | | | | | | 100 | | | | |
| Example 7 containing 50 mass % of propyleneglycol methylether acetate | | | | | | | 100 | | | |
| Example 8 containing 50 mass % of diethyleneglycol ethylether acetate | | | | | | | | 100 | | |
| Example 9 containing 50 mass % of propyleneglycol methylether acetate | | | | | | | | | 100 | |
| Example 10 containing 50 mass % of propyleneglycol methylether acetate | | | | | | | | | | 100 |
| 2-ethyl-4-methyl imidazole | 2.5 | 2.5 | 2.5 | 2.5 | 2.5 | 2.5 | | 2.5 | 2.5 | 2.5 |
| Epikote 1002*¹ (70 mass % diethyl ene glycol ethylether acetate solution) | 50.0 | 48.0 | 47.0 | 55.1 | 55.2 | 55.0 | 49.9 | 45.0 | 47.8 | 77.2 |
| TSA-750S*² | 1.8 | 1.8 | 1.8 | 1.8 | 1.8 | 1.8 | | 1.8 | 1.8 | 1.8 |

*¹epoxy resin (produced by Japan Epoxy Resin K.K.)
*²polyalkylsiloxane (produced by GE Toshiba Silicones)

TABLE 2

| | Examples | | | | | | | | | | | Comp. Ex. |
|---|---|---|---|---|---|---|---|---|---|---|---|---|
| Polyurethane containing carboxyl group | 32 | 33 | 34 | 35 | 36 | 37 | 38 | 39 | 40 | 41 | 42 | 2 |
| Example 11 containing 50 mass % of diethyldiglycol | 100 | | | | | | | | | | | |
| ethylether acetate | | | | | | | | | | | | |
| Example 12 containing 50 mass % of propyleneglycol | | 100 | | | | | | | | | | |
| methylether acetate | | | | | | | | | | | | |
| Example 13 containing 50 mass % of propyleneglycol | | | 100 | | | | | | | | | |
| methylether acetate | | | | | | | | | | | | |
| Example 14 containing 50 mass % of propyleneglycol | | | | 100 | | | | | | | | |
| methylether acetate | | | | | | | | | | | | |
| Example 15 containing 50 mass % of propyleneglycol | | | | | 100 | | | | | | | |
| methylether acetate | | | | | | | | | | | | |
| Example 16 containing 50 mass % of propyleneglycol | | | | | | 100 | | | | | | |
| methylether acetate | | | | | | | | | | | | |
| Example 17 containing 50 mass % of propyleneglycol | | | | | | | 100 | | | | | |
| methylether acetate | | | | | | | | | | | | |
| Example 18 containing 50 mass % of propyleneglycol | | | | | | | | 100 | | | | |
| methylether acetate | | | | | | | | | | | | |
| Example 19 containing 50 mass % of Υ-butyrolactone | | | | | | | | | 100 | | | |
| Example 20 containing 50 mass % of diethyldiglycol | | | | | | | | | | 100 | | |
| ethylether acetate | | | | | | | | | | | | |
| Example 21 containing 50 mass % of diethyldiglycol | | | | | | | | | | | 100 | |
| ethylether acetate | | | | | | | | | | | | |
| Comparative Example 1 | | | | | | | | | | | | 100 |
| containing 50 mass % of diethyldiglycol ethylether acetate | | | | | | | | | | | | |
| 2-ethyl-4-methyl imidazole | 2.5 | 2.5 | 2.5 | 2.5 | 2.5 | 2.5 | 2.5 | 2.5 | 2.5 | 2.5 | 2.5 | 2.5 |
| Epikote 1002*¹ (70 mass % diethyl ene glycol ethylether | 31.2 | 66.0 | 50.1 | 49.9 | 75.1 | 70.6 | 73.0 | 45.0 | 31.9 | 31.2 | 33.7 | 21.5 |
| acetate solution) | | | | | | | | | | | | |
| Phthalocyanine green | 0.5 | 0.5 | 0.5 | 0.5 | 0.5 | 0.5 | 0.5 | 0.5 | 0.5 | 0.5 | 0.5 | 0.5 |
| Aerosil #380*² | 2.5 | 2.5 | 2.5 | 2.5 | 2.5 | 2.5 | 2.5 | 2.5 | 2.5 | 2.5 | 2.5 | 2.5 |
| TSA-750S*³ | 1.8 | 1.8 | 1.8 | 1.8 | 1.8 | 1.8 | 1.8 | 1.8 | 1.8 | 1.8 | 1.8 | 1.8 |

*¹epoxy resin (produced by Japan Epoxy Resin K.K.)
*²Silicon dioxide (produced by NIPPON AEROSIL CO., LTD.)
*³polyalkylsiloxane (produced by GE Toshiba Silicones)

### Evaluation Test of Thermosetting Resin Compositions of Examples 22 to 31

Evaluation tests were performed on adhesiveness, warpage resistance, flexibility, plating resistance, soldering heat resistance and long-term reliability in a manner as described below. The results are shown in Table 3.

### Adhesiveness:

The thermosetting resin compositions according to Examples 22 to 31 were each applied on a polyimide film (KAPTON® 300H; produced by DuPont-Toray Co., Ltd.) having a thickness of 75 μm by using a bar coater to a film thickness of about 25 μm. The film after coating was dried for 30 minutes at 80° C. and, then, cured for one hour at 150° C. A cross-cut test was performed on the thus-cured film in accordance with JISK5600.

### Warpage Resistance:

The thermosetting resin compositions according to Examples 22 to 31 were each applied on a polyimide film [KAPTON® 100H; produced by DuPont-Toray Co., Ltd.] having a thickness of 25 μm by using a bar coater such to a film thickness of about 25 μm. The film after coating was dried for 30 minutes at 80° C. and, then, cured for one hour at 150° C. The thus-thermally-cured film was cut out in a circular shape having a diameter of 50 mm and the thus-cut-out film was left to stand with a printed face up for 24 hours at 23° C. and 60% RH and then, an evaluation test was performed in accordance with the following criteria:

O: maximum warping height is less than 5 mm; and

X: maximum warping height is 5 mm or more.

### Flexibility:

The thermosetting resin compositions according to Examples 22 to 31 were each applied by using a bar coater to a film thickness of about 25 μm. The film was dried for 30 minutes at 80° C. and then, cured for one hour at 150° C. As for a substrate, a polyimide film,[KAPTON® 100H; produced by DuPont-Toray Co., Ltd.] having a thickness of 25 μm was used. The polyamide film on which a solder resist composition was applied and thermally cured was bended at 180° C. with the coated face outside and then, by checking the presence of whitening in the cured film, an evaluation test was performed in accordance with the following criteria:

O: whitening was not observed in the cured film; and

X: whitening or crack was observed in the cured film.

### Plating Resistance:

A printing substrate made of a polyimide film (thickness: 25 μm) on which a copper foil (thickness: 12 μm) was laminated on one surface [UPICEL® N; produced by Ube Industries, Ltd.] was washed with an acidic degreasing agent AC-401 (trade name; produced by Nippon Polytech Corporation) and then with water. Then, the substrate was dried for 3 minutes at 70° C. The thermosetting resin compositions according to Examples 22 to 31 were each applied on the resultant printing substrate by using a bar coater to a film thickness of about 25 μm. The resultant printing substrate was dried for 30 minutes at 80° C., cured for one hour at 150° C., washed with water, dipped in an acidic degreasing agent ICP Clean 91 (trade name; produced by Okuno Chemical Industries Co., Ltd.) at 23° C. for one minute, washed with water, dipped in an aqueous 10% sulfuric acid solution for one minute at 23° C. and then, washed with water. The substrate thus cleaned was dipped in a tin plating solution (TINPOSIT LT-34; produced by Rohm & Haas Co.) for 3 minutes at 70° C., washed with water and, then, dipped in warm water at 70° C. The thus-plated substrate was subjected to a heating treatment for 2 hours at 120° C. and then, the cured film was visually inspected. The plating resistance was evaluated on the following criteria:

O: neither change in color of the cured film nor creeping of plating into under the cured film was observed; and

X: some change in color of the cured film or creeping of plating into under the cured film was observed.

### Soldering Heat Resistance:

In accordance with a testing method defined by JIS-C-6481, the thermosetting resin compositions according to Examples 22 to 31 were each applied by using a bar coater to a film thickness of about 25 μm, dried for 30 minutes at 80° C. and then, thermally cured for one hour at 150° C. As for the substrate, a printing substrate made of a polyimide film (thickness: 50 μm) on which a copper foil (thickness: 35 μm) was laminated at one surface [UPICEL® N; produced by Ube Industries, Ltd.] was washed with an aqueous 1% sulfuric acid solution and then with water, dried in air flow and used. The substrate on which the solder resist was applied and then thermally cured was allowed to float in a soldering bath for 10 seconds at 260° C. Then, the cured film was visually inspected, to thereby evaluate the soldering resistance in accordance with the following criteria:

O: neither blistering of the cured film nor creeping of soldering into under the cured film was observed; and

X: blistering of the cured film or creeping of soldering into under the cured film was observed.

### Long-Term Reliability:

On an IPC-C (comb-like pattern) which is a commercially available substrate (IPC specification), the thermosetting resin compositions according to Examples 22 to 31 were each applied by using a bar coater to a film thickness of about 25 μm, dried for 30 minutes at 80° C. and then, thermally cured for one hour at 150° C. The resultant substrate was left to stand in an atmosphere of 85° C. and 85% RH for 500 hours with a bias voltage of 100 V being applied thereon and the electrical insulation property was evaluated in accordance with the following criteria:

O: neither migration nor reduction of insulation resistance was observed; and

X: migration or reduction of insulation resistance was observed.

TABLE 3

| | Example | | | | | | | | | |
|---|---|---|---|---|---|---|---|---|---|---|
| | 22 | 23 | 24 | 25 | 26 | 27 | 28 | 29 | 30 | 31 |
| Adhesiveness | ◯ | ◯ | ◯ | ◯ | ◯ | ◯ | ◯ | ◯ | ◯ | ◯ |
| Warping property | ◯ | ◯ | ◯ | ◯ | ◯ | ◯ | ◯ | ◯ | ◯ | ◯ |
| Flexibility | ◯ | ◯ | ◯ | ◯ | ◯ | ◯ | ◯ | ◯ | ◯ | ◯ |
| Plating resistance | ◯ | ◯ | ◯ | ◯ | ◯ | ◯ | ◯ | ◯ | ◯ | ◯ |
| Soldering heat resistance | ◯ | ◯ | ◯ | ◯ | ◯ | ◯ | ◯ | ◯ | ◯ | ◯ |
| Long-term reliability | ◯ | ◯ | ◯ | ◯ | ◯ | ◯ | ◯ | ◯ | ◯ | ◯ |

### Evaluation Test of Thermosetting Resin Compositions of Examples 32 to 42 and Comparative Example 2

Evaluation tests were performed on adhesiveness, warpage resistance, flexibility, plating resistance, soldering heat resistance and long-term reliability in a manner as described below. The results are shown in Table 4.

### Adhesiveness:

The thermosetting resin compositions according to Examples 32 to 42 and Comparative Example 2 were each applied through screen printing on a polyimide film (KAPTON® 300H; produced by DuPont-Toray Co., Ltd.) having a thickness of 75 μm with a 100-mesh polyester screen plate. The film after printing was dried for 30 minutes at 80° C. and, then, thermally cured for one hour at 150° C. A cross-cut test was performed on the thus thermally cured film in accordance with JISK5600.

### Warpage Resistance:

The thermosetting resin compositions according to Examples 32 to 42 and Comparative Example 2 were each applied through screen printing on a polyimide film having a thickness of 25 μm with a 100-mesh polyester screen plate. The film after printing was dried for 30 minutes at 80° C. and, then, thermally cured for one hour at 150° C. The thus-thermally-cured film was cut out in a circular shape having a diameter of 50 mm and the thus-cut-out film was left to stand with a printed face up for 24 hours at 23° C. and 60% RH and then, an evaluation test was performed in accordance with the following criteria:

O: maximum warping height is less than 5 mm; and

X: maximum warping height is 5 mm or more.

### Flexibility:

The thermosetting resin compositions according to Examples 32 to 42 and Comparative Example 2 were each applied through screen printing with a 100-mesh polyester screen plate. The film was dried for 30 minutes at 80° C. and then, cured for one hour at 150° C. As for a substrate, a polyimide film [KAPTON® 100H; produced by DuPont-Toray Co., Ltd.] having a thickness of 25 μm was used. The polyamide film on which a solder resist composition was applied and thermally cured was bended at 180° C. with the coated face outside and then, by checking the presence of whitening in the cured film, an evaluation test was performed in accordance with the following criteria:

O: no whitening was observed in the cured film; and

X: whitening or crack was observed in the cured film.

### Plating Resistance:

A printing substrate made of a polyimide film (thickness: 25 μm) on which a copper foil (thickness: 12 μm) was laminated on one surface [UPICEL® N; produced by Ube Industries, Ltd.] was washed with an acidic degreasing agent AC-401 (trade name; produced by Nippon Polytech Corporation) and then with water. Then, the substrate was dried for 3 minutes at 70° C. The thermosetting resin compositions according to Examples 32 to 42 and Comparative Example 2 were each applied on the resultant printing substrate through screen printing with a 100-mesh polyester screen plate. The resultant printing substrate was dried for 30 minutes at 80° C., cured for one hour at 150° C., washed with water, dipped in an acidic degreasing agent ICP Clean 91 (trade name; produced by Okuno Chemical Industries Co., Ltd.) at 23° C. for one minute, washed with water, dipped in an aqueous 10% sulfuric acid solution for one minute at 23° C. and then, washed with water. The substrate thus cleaned was dipped in a tin plating solution (TINPOSIT LT-34; produced by Rohm & Haas Co.) for 3 minutes at 70° C., washed with water and, then, dipped in warm water at 70° C. The thus-plated substrate was subjected to a heating treatment for 2 hours at 120° C. and then, the cured film was visually inspected. The plating resistance was evaluated on the following criteria:

O: neither change in color of the cured film nor creeping of plating into under the cured film was observed; and

X: some change in color of the cured film or creeping of plating into under the cured film was observed.

### Soldering Heat Resistance:

In accordance with a testing method defined by JIS-C-6481, the thermosetting resin compositions according to Examples 32 to 42 and Comparative Example 2 were each applied through screen printing with a 100-mesh polyester screen plate, dried for 30 minutes at 80° C. and then, thermally cured for one hour at 150° C. As for the substrate, a printing substrate made of a polyimide film (thickness: 50 μm) on which a copper foil (thickness: 35 μm) was laminated at one surface [UPICEL® N; produced by Ube Industries, Ltd.] was washed with an aqueous 1% sulfuric acid solution and then with water, dried in air flow and used. The substrate on which the solder resist was applied and then thermally cured was allowed to float in a soldering bath for 10 seconds at 260° C. Then, the cured film was visually inspected, to thereby evaluate the soldering resistance in accordance with the following criteria:

O: neither blistering of the cured film nor creeping of soldering into under the cured film was observed; and

X: blistering of the cured film or creeping of soldering into under the cured film was observed.

### Long-Term Reliability:

On a IPC-C (comb-like pattern) which is a commercially available substrate (IPC specification), the thermosetting resin compositions according to Examples 32 to 42 and Comparative Example 2 were each applied through screen printing with a 100-mesh polyester screen plate, dried for 30 minutes at 80° C. and then, thermally cured for one hour at 150° C. The resultant substrate was left to stand in an atmosphere of 85° C. and 85% RH for 500 hours with a bias voltage of 100 V being applied thereon and the electrical insulation property was evaluated in accordance with the following criteria:

O: neither migration nor reduction of insulation resistance was observed; and

X: migration or reduction of insulation resistance was observed.

TABLE 4

| | | | | | | | | | | | | Comp. |
|---|---|---|---|---|---|---|---|---|---|---|---|---|
| | Example | | | | | | | | | | | Example |
| | 32 | 33 | 34 | 35 | 36 | 37 | 38 | 39 | 40 | 41 | 42 | 2 |
| Adhesiveness | ◯ | ◯ | ◯ | ◯ | ◯ | ◯ | ◯ | ◯ | ◯ | ◯ | ◯ | ◯ |
| Warping property | ◯ | ◯ | ◯ | ◯ | ◯ | ◯ | ◯ | ◯ | ◯ | ◯ | ◯ | ◯ |
| Flexibility | ◯ | ◯ | ◯ | ◯ | ◯ | ◯ | ◯ | ◯ | ◯ | ◯ | ◯ | ◯ |
| Plating resistance | ◯ | ◯ | ◯ | ◯ | ◯ | ◯ | ◯ | ◯ | ◯ | ◯ | ◯ | X |
| Soldering heat | ◯ | ◯ | ◯ | ◯ | ◯ | ◯ | ◯ | ◯ | ◯ | ◯ | ◯ | X |
| resistance | | | | | | | | | | | | |
| Long-term reliability | ◯ | ◯ | ◯ | ◯ | ◯ | ◯ | ◯ | ◯ | ◯ | ◯ | ◯ | X |

### INDUSTRIAL APPLICABILITY

As has been described above, according to the invention, a thermosetting resin composition excellent in adhesiveness to a substrate, a low warpage property, flexibility, plating resistance, soldering heat resistance and long-term reliability under high temperature/high humidity conditions and a carboxyl group-containing polyurethane serving as raw material for the composition can be provided. The invention can be utilized in the fields of electric insulation materials such as a solder resist and an interlayer insulation film, an IC or ultra LSI sealing materials, a laminate and the like.

The thermosetting resin composition according to the invention can be produced at a relatively low cost as compared with a liquid polyimide ink which has conventionally been used. In the conventional resist ink, warpage was generated due to large shrinkage at the time of curing and shrinkage at the time of cooling after curing, to thereby cause a deterioration of yield. However, the thermosetting resin composition according to the invention can simultaneously attain not only low warping property but also plating resistance and soldering heat resistance which have been incompatible with the low warping property in conventional resist ink and can also form a protective film excellent in the long-term reliability under high temperature/high humidity conditions with favorable productivity at a low cost.

1. A carboxyl group-containing polyurethane, which is obtained by reacting (a) a polyisocyanate compound, (b) a polycarbonate diol having a molecular weight of 300 to 50,000, (c) a dihydroxy compound having a carboxyl group and when necessary (d) a monohydroxy compound.

2. The carboxyl group-containing polyurethane according to claim 1, wherein 10 mol % or more of diol components constituting (b) the polycarbonate diol having a molecular weight of 300 to 50,000 consists of alicyclic compound having 6 to 30 carbon atoms.

3. The carboxyl group-containing polyurethane according to claim 2, wherein the diol containing alicyclic compound having 6 to 30 carbon atoms is at least one kind selected from a group consisting of 1,4-cyclohexane dimethanol, 1,3-cyclohexane dimethanol, 1,4-cyclohexane diol, 1,3-cyclohexane diol, tricyclodecane dimethanol and pentacyclopentadecane dimethanol.

4. The carboxyl group-containing polyurethane according to claim 1, wherein the number average molecular weight is from 500 to 100,000 and the acid value is from 5 to 150 mg KOH/g.

5. The carboxyl group-containing polyurethane according to claim 1, wherein (c) the dihydroxy compound having a carboxyl group is dimethylolpropionic acid and/or dimethylolbutanoic acid.

6. The carboxyl group-containing polyurethane according to claim 1, wherein 10 mol % or more of (a) the polyisocyanate compound is an alicyclic compound having 6 to 30 carbon atoms excluding carbon atoms in the isocyanate groups.

7. The carboxyl group-containing polyurethane according to claim 1, wherein (a) the polyisocyanate compound is at least one kind selected from a group consisting of 1,4-cyclohexane diisocyanate, isophorone diisocyanate, methylene-bis(cyclohexyl isocyanate), cyclohexane-1,3-dimethylene diisocyanate and cyclohexane-1,4-dimethylene diisocyanate.

8. The carboxyl group-containing polyurethane according to claim 1, wherein (d) the monohydroxy compound is at least one kind selected from a group consisting of hydroxyethyl acrylate, hydroxyethyl(meth)acrylate, allyl alcohol, glycolic acid and hydroxypivalic acid.

9. The carboxyl group-containing polyurethane according to claim 1, wherein (d) the monohydroxy compound is at least one kind selected from a group consisting of methanol, ethanol, n-propanol, isopropanol, n-butanol, isobutanol, sec-butanol and t-butanol.

10. A thermosetting resin composition, comprising:
(A) 100 parts by mass of a carboxyl group-containing polyurethane resin in which 10% by mol or more of diol components constituting a polycarbonate diol having a molecular weight of from 300 to 50,000 uses an alicyclic compound having 6 to 30 carbon atoms as a raw material and
(B) 1 to 100 parts by mass of epoxy resin.

11. The thermosetting resin composition according to claim 10, wherein the carboxyl group-containing polyurethane resin (A) is a carboxyl group-containing polyurethane resin described in claim 2.

12. The thermosetting resin composition according to claim 10, wherein the epoxy resin (B) is at least one type selected from among a bisphenol A type epoxy resin, a bisphenol F type epoxy resin, a phenol novolak type epoxy resin, an o-cresol novolak type epoxy resin, a biphenyl type epoxy resin, an amine type epoxy resin, a hetero ring-containing epoxy resin and an alicyclic epoxy resin.

13. The thermosetting resin composition according to claim 10, wherein the acid value of the carboxyl group-containing polyurethane resin (A) is from 5 to 150 mg KOH/g.

14. The thermosetting resin composition according to claim 10, wherein the amount of epoxy group in the epoxy resin (B) is from 0.2 to 2 equivalents with respect to the carboxyl group of the carboxyl group-containing polyurethane resin (A).

15. The thermosetting resin composition according to claim 10, wherein the number average molecular weight of the carboxylic group-containing polyurethane resin (A) is from 500 to 100,000.

16. The thermosetting resin composition according to claim 10, wherein a non-nitrogen-containing polar solvent is used as an organic solvent in both (A) 100 parts by mass of a carboxyl group-containing polyurethane resin in which 10% by mol or more of diol components constituting a polycarbonate diol having a molecular weight of from 300 to 50,000 uses an alicyclic compound having 6 to 30 carbon atoms as a raw material and (B) 1 to 100 parts by mass of epoxy resin.

17. The thermosetting resin composition according to claim 10, wherein (A) 100 parts by mass of a carboxyl group-containing polyurethane resin in which 10% by mol or more of diol components constituting a polycarbonate diol having a molecular weight of from 300 to 50,000 uses an alicyclic compound having 6 to 30 carbon atoms as a raw material, (B) 1 to 100 parts by mass of epoxy resin and (C) from 1 to 90 parts by mass of inorganic and/or organic fine particles are blended in.

18. The thermosetting resin composition according to claim 10, wherein a curing agent (D) is contained in an amount of from 0.1 to 25% by mass based on the thermosetting resin components (A)+(B).

19. The thermosetting resin composition according to claim 10, wherein the curing agent (D) is at least one type selected from among an amine, a quaternary ammonium salt, an acid anhydride, polyamide, a nitrogen-containing heterocyclic compound and an organic metal compound.

20. A paste for forming a film, using the thermosetting composition according to claim 10.
